(19) United States
(12) Patent Application Publication
(10) Pub. No.: US 2009/0040168 A1
(43) Pub. Date: Feb. 12, 2009

(54) LIQUID CRYSTAL DISPLAY WITH BLOCKING CIRCUITS

(76) Inventor: Wo-Chung Liu, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 11/854,554

(22) Filed: Sep. 13, 2007

(30) Foreign Application Priority Data
Aug. 8, 2007 (TW) 096129295

(51) Int. Cl. G09G 3/36

(52) U.S. Cl. 345/100

(57) ABSTRACT

A gate driver of a liquid crystal display includes a plurality of cascaded gate-driving circuits for outputting a plurality of scanning signals. Each of the gate-driving circuits includes a shift register for outputting scanning signals according to the clock pulses and the scanning signal outputted by the former gate-driving circuit, and a blocking circuit for blocking the scanning signals a predetermined time period. Thus the scanning signals generated by adjacent gate-driving circuits do not overlap, and the image quality of the liquid crystal display can be improved.

### BACKGROUND OF THE INVENTION

1. Field of the Invention

The present invention relates to a liquid crystal display and a driving circuit thereof, and more particularly to a liquid crystal display with blocking circuits for blocking scan signals thereby generating non-overlapping scan signals.

2. Description of Related Art

FIG. 4A is a block diagram showing a prior art liquid crystal display 400. The liquid crystal display 400 includes a gate driver 410, a data driver 420, a pixel matrix 430 and a timing controller 440. The pixel matrix 430 includes a plurality of gate lines 104 arranged equidistantly on the substrate 402, data lines 106 perpendicular to the gate lines 104, and pixels 107 each including a thin-film-transistor (TFT) 109 and a pixel capacitor 108. The TFT 109 is connected to a gate line 104, a data line 106, and the pixel capacitor 108. The gate driver 410 includes a first shift register 411, a second shift register 411, . . . , and an Nth shift register 411, wherein N is a positive integer greater than 1. The pth (1≦p≦N) shift register 411 outputs a scan signal Sp according to clock pulses CLK and a start pulse STP (p=1) outputted by the timing controller 440 or a scan signal S(p−1) (p≧2), so as to turn on pixels at pth row of the pixel matrix 430 to receive data signals outputted by the data driver 420.

FIG. 4B is a block diagram showing the wiring diagram of the gate driver 410 and pixel matrix 430 (taking PMOS structure of TFT for examples) in FIG. 4A. FIG. 4C is a timing diagram showing the timing of the clock pulses CLK, the scan signals S(p−1), Sp and S(p+1) outputted by the gate driver 410 in FIG. 4B. According to the clock pulses CLK outputted by the timing controller 440, the scan signal S(p−1) is at a low voltage level (˜VSS) during the time period T(p−1), and the pth shift register 411 and the (p+1)th shift register 411 have no signal output in the time period T(p−1). That is, the scan signals Sp and S(p+1) are at a high voltage level (˜VDD). In the time period Tp, the pth shift register 411 outputs the scan signal Sp with the low voltage level, according to the clock signal CLK and whether scan signal S(p−1) is at the low voltage level. At the same time, the (p−1)th shift register 411 will be turned off. Analogously, the (p+1)th shift register 411 will output the scan signal S(p+1) at the low voltage level in the time period T(p+1).

However, due to the characteristics of the switch devices in the shift registers, when the pth shift register 411 is triggered to output the scan signal S(p−1) at the low voltage level after the end of the time period T(p−1), the scan signal S(p−1) is still at the low voltage level. Thus, the (p−1)th and pth gate lines are both turned on at the same time. This will deteriorate the image quality of the liquid crystal display 400.

### SUMMARY OF THE INVENTION

The present invention provides a gate driver comprising a plurality of cascaded gate driving circuits for outputting a plurality of scan signals. Each of the gate driving circuits comprises a shift register for outputting a scan signal according to clock pulses and a scan signal outputted by a former gate driving circuit, and a blocking circuit coupled to the shift register for blocking the scan signal generated by the shift register a predetermined time period.

The present invention further provides a liquid crystal display comprising a substrate, a plurality of gate lines arranged on the substrate, a plurality of data lines arranged on the substrate and intersecting the gate lines, and a plurality of pixels each comprising a thin film transistor and a pixel capacitor. The thin film transistor is coupled to a data line and a gate line. The pixel capacitor is coupled to the thin film transistor. The liquid crystal display further comprises a data driver for outputting a plurality of data signals to the data lines, and a gate driver comprising a plurality of cascaded gate driving circuits for outputting a plurality of scan signals. Each of the gate driving circuits comprises a shift register for outputting a scan signal according to clock pulses and a scan signal outputted by a former gate driving circuit, and a blocking circuit coupled to the shift register for blocking the scan signal generated by the shift register a predetermined time period.

The present invention still further provides a method for generating a non-overlapping scan signal in a liquid crystal display. The method comprises generating a scan signal by a shift register according to clock pulses and a scan signal outputted by a previous shift register, and when the shift register outputs the scan signal for a duty cycle, generating control signals to control a blocking circuit coupled to the shift register to block the scan signal generated by the shift register for a predetermined time period.

These and other objectives of the present invention will become apparent to those of ordinary skill in the art after reading the following detailed description of the preferred embodiment that is illustrated in the various figures and drawings.

### BRIEF DESCRIPTION OF THE DRAWINGS

FIG. 1A is a block diagram showing circuits of a liquid crystal display according to a preferred embodiment of the invention.

FIG. 1B and FIG. 1C are the first block diagram and timing diagram of the (p−1)th, pth, and (p+1)th gate-driving circuits of the liquid crystal display in FIG. 1A.

FIG. 1D and FIG. 1E are the second block diagram and timing diagram of the (p−1)th, pth, and (p+1)th gate-driving circuits of the liquid crystal display FIG. 1A.

FIG. 1F is the third block diagram of the (p−1)th and pth gate-driving circuits of FIG. 1A.

FIG. 1G is the fourth block diagram of the (p−1)th and pth gate-driving circuits of FIG. 1A.

FIG. 2A and FIG. 2B are the block diagram and timing diagram of the second embodiment of the (p−1)th, pth, and (p+1)th gate-driving circuits according to the present invention.

FIG. 3A and FIG. 3B are the block diagram and timing diagram of the third embodiment of the (p−1)th, pth, and (p+1)th gate-driving circuits according to the present invention.

FIG. 4A is a block diagram showing a prior art liquid crystal display.

FIG. 4B is a block diagram showing the wiring diagram of the gate driver and pixel matrix in FIG. 4A.

FIG. 4C is a timing diagram showing the timing of the clock pulses CLK, the scan signals S(p−1), Sp and S(p+1) outputted by the gate driver in FIG. 4B.

### DETAILED DESCRIPTION

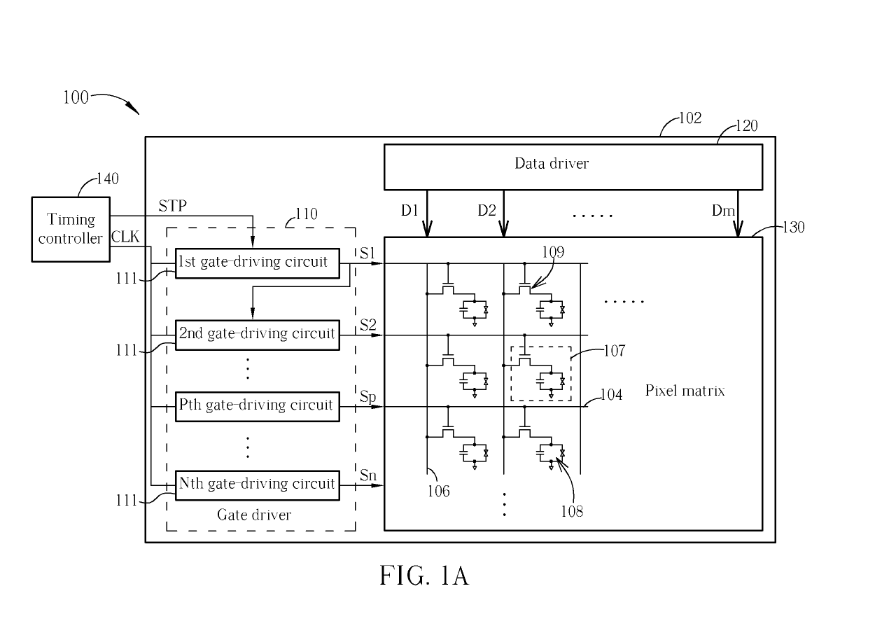

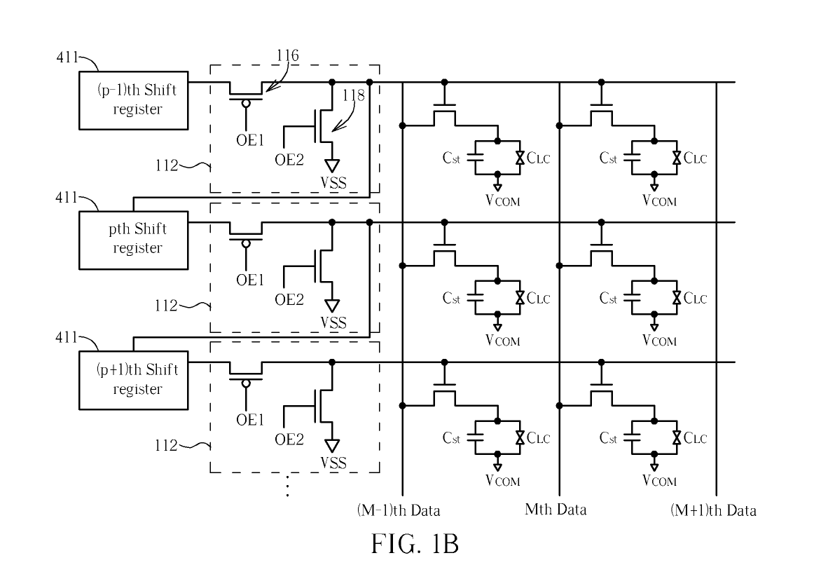

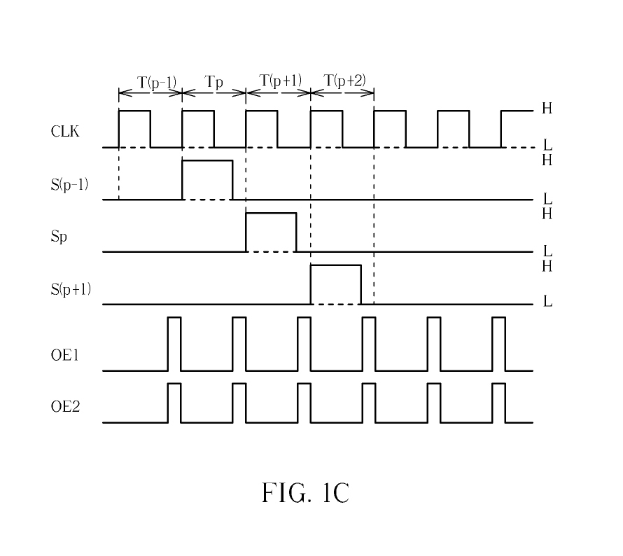

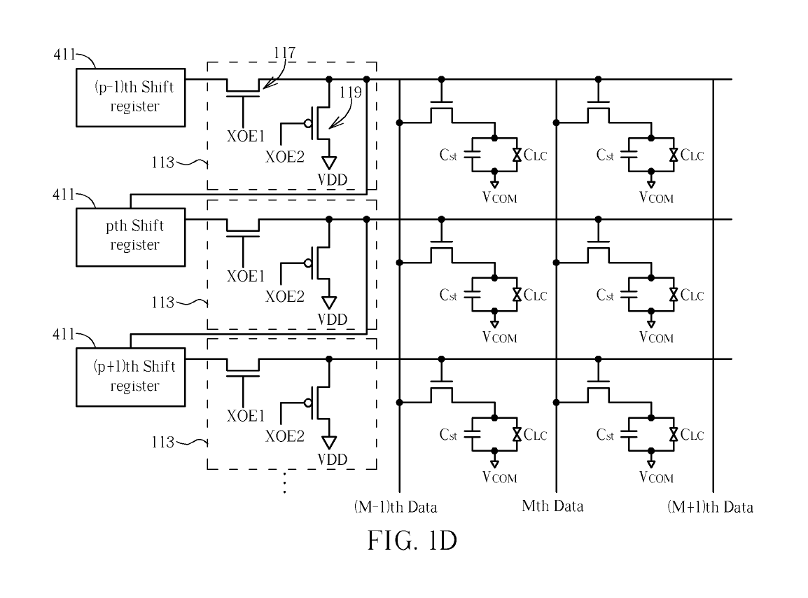

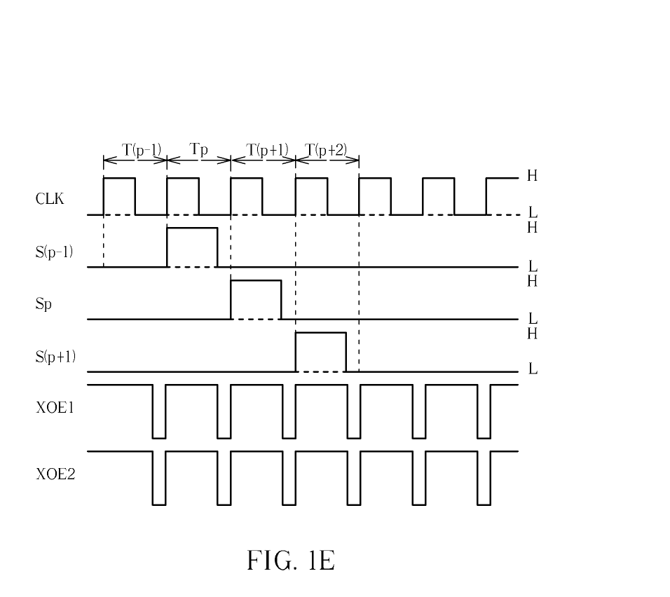

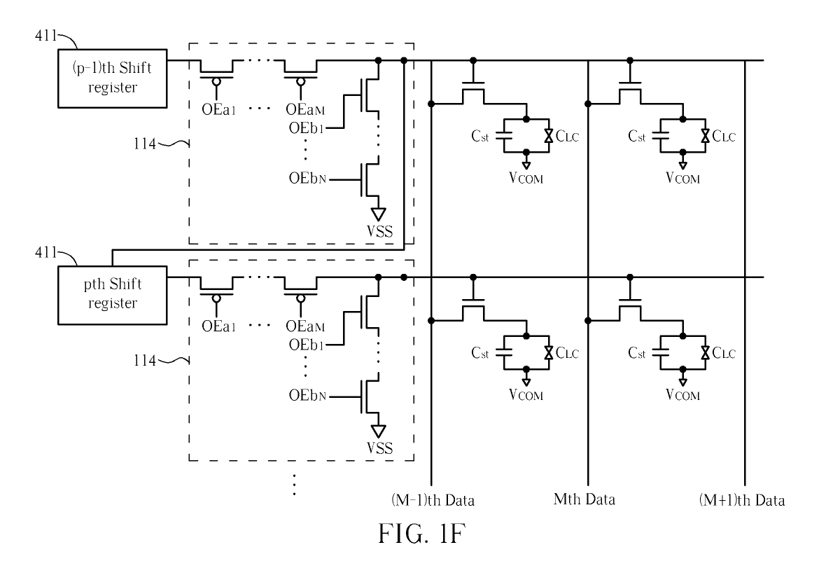

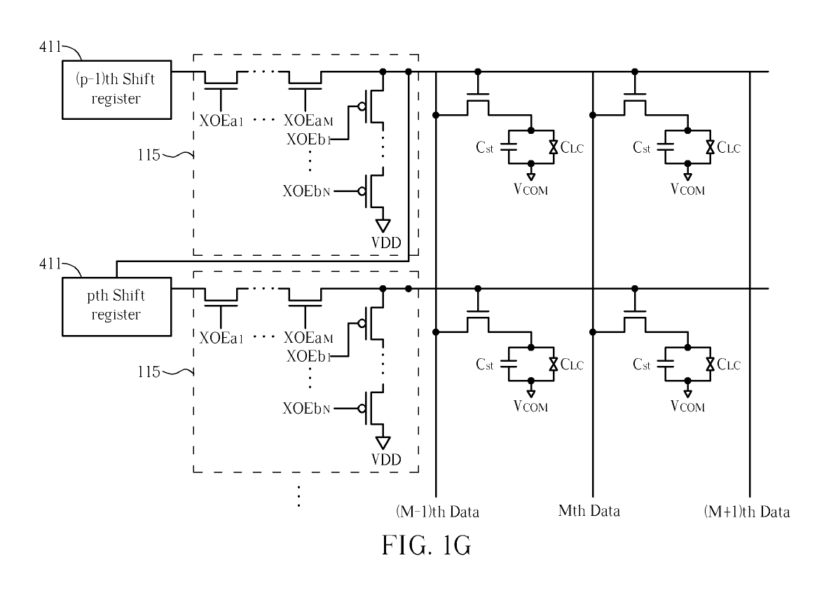

FIG. 1A is a block diagram showing circuits of a liquid crystal display 100 according to a preferred embodiment of the invention. Referring to FIG. 1A, the liquid crystal display 100 includes a substrate 102, a gate driver 110, a data driver 120, a pixel matrix 130 and a timing controller 140, wherein the peripheral circuits of the liquid crystal display 100 are mainly formed with CMOS, while the TFT of the pixel matrix 130 is constructed as the NMOS structure on the substrate 102. The pixel matrix 130 includes a plurality of gate lines 104 arranged equidistantly on the substrate 102, data lines 106 perpendicular to the gate lines 104, and pixels 107 including a thin-film-transistor (TFT) 109 connected to a gate line 104, a data line 106, and a pixel capacitor 108. The gate driver 110 includes a plurality of cascaded gate-driving circuits for outputting a plurality of scan signals S1˜Sn. Those scan signals S1˜Sn sequentially turn on the gate lines, so as to receive data signals D1˜Dm outputted by the data driver 120, wherein n and m are positive integers greater than 1. The pth (1≦p≦N) gate-driving circuits 111 outputs a scan signal Sp according to a clock signal CLK and a start pulse STP (p=1) outputted by the timing controller 140 or a scan signal S(p−1) (p≧1), so as to turn on a pth row of pixels of the pixel matrix 130 to receive data signals outputted by the data driver 120.

FIG. 1B and FIG. 1C are the first block diagram and timing diagram of the (p−1)th, pth, and (p+1)th gate-driving circuits 111 of FIG. 1A. Each blocking circuit 112 of the gate-driving circuits includes a PMOS switch 116 and an NMOS switch 118. The source of the PMOS switch 116 is connected to the shift register 411. The source of the NMOS switch 118 is connected to the low-voltage-level source (VSS), and its drain is connected the drain of the PMOS switch 16. According to the clock pulses CLK outputted by the timing controller 140, the scan signal Sp outputted by the pth gate-driving circuits is switched to a high voltage level (˜VDD) at the end of the time period Tp. A small time period before the time period Tp ends, two control signals OE1 and OE2 are simultaneously set to the high voltage level (˜VDD) and maintained at the high voltage level till the end of the time period Tp, so that the rising edge of the scan signal Sp is triggered after the falling edge of the scan signal S(p−1) is triggered. That is, the control signals OE1 and OE2 control the blocking circuits 112 connected to the (p−1)th and the pth shift registers 411 to block the scan signals up to the small time period, so that the gate-driving circuits 111 can generate non-overlapping scan signals to corresponding gate lines. Analogously, the (p+1)th gate-driving circuit 111 outputs the scan signal S(p+1) in the time period T(p+2) in a similar manner.

FIG. 1D and FIG. 1E are the second block diagram and timing diagram of the (p−1)th, pth, and (p+1)th gate-driving circuits 111 of FIG. 1A, Each blocking circuit 113 of the gate-driving circuits 111 includes an NMOS switch 117 and a PMOS switch 119. The drain of the NMOS switch 117 is connected to the shift register 411, while the drain of the PMOS switch 119 is connected to the high-voltage-level source (VDD), and its source is connected the source of the NMOS switch 117. According to the clock pulses CLK outputted by the timing controller 140, the scan signal Sp outputted by the pth gate-driving circuits is switched to a high voltage level (˜VDD) at the end of the time period Tp. A small time period before the time period Tp ends, two control signals XOE1 and XOE2 are simultaneously set to the low voltage level (˜VSS) and maintained at the low voltage level till the end of the time period Tp, so that the rising edge of the scan signal Sp is triggered after the falling edge of the scan signal S(p−1) is triggered. That is, the control signals XOE1 and XOE2 control the blocking circuits 113 connected to the (p−1)th and the pth shift registers 411 to block the scan signals up to the small time period, so that the gate-driving circuits 111 can generate non-overlapping scan signals to corresponding gate lines. Analogously, the (p+1)th gate-driving circuit 111 outputs the scan signal S(p+1) at the time period T(p+2) in a similar manner.

FIG. 1F is the third block diagram of the (p−1)th and pth gate-driving circuits of FIG. 1A. Each blocking circuit 114 of the gate-driving circuits includes a plurality of PMOS switches and a plurality of NMOS switches. The source of one of the PMOS switch is connected to the shift register, while the source of one of the NMOS switch is connected to the low-voltage-level source (VSS). In view of the design of TFT with several types of aspect ratio (the value of width/length), a plurality of control signals (OEa₁, OEa₂, . . . ,OEa_{M}, OEb₁, OEb₂, and OEb_{N}) are used to control the PMOS and NMOS switches of blocking circuits 114 connected to the shift registers 411 for blocking the scan signals up to the small time period, thereby generating non-overlapping scan signals to corresponding gate lines.

FIG. 1G is the fourth block diagram of the (p−1)th and pth gate-driving circuits of FIG. 1A. Each blocking circuit 114 of the gate-driving circuits includes a plurality of NMOS switches and a plurality of PMOS switches. The drain of one of the NMOS switch is connected to the shift register, while the drain of one of the PMOS switch is connected to the high-voltage-level source (VDD). In view of the design of TFT with several types of aspect ratio (the value of width/length), a plurality of control signals (XOEa₁, XOEa₂, . . . , XOEa_{M}, XOEb₁, XOEb₂, and XOEb_{N}) are used to control the PMOS and NMOS switches of blocking circuits 114 connected to the shift registers 411 for blocking the scan signals up to the small time period, thereby generating non-overlapping scan signals to corresponding gate lines.

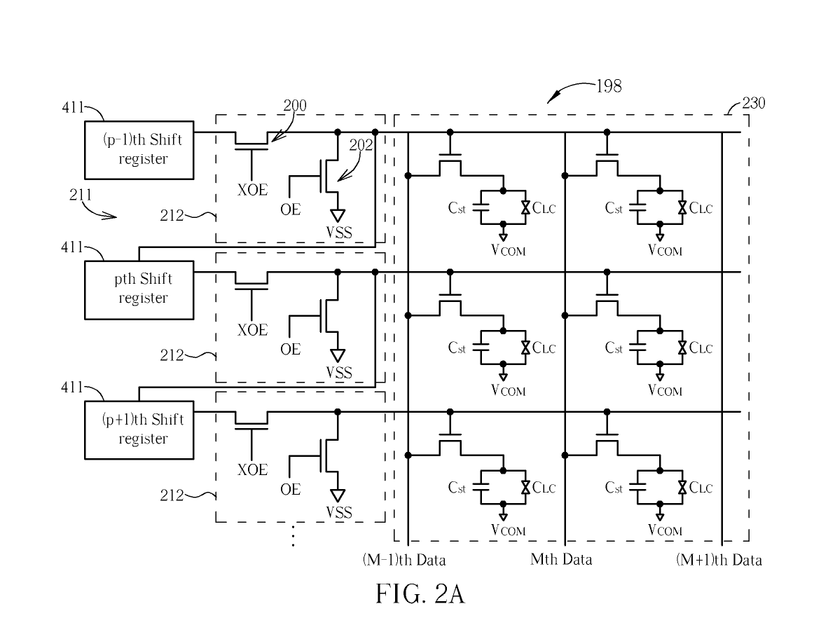

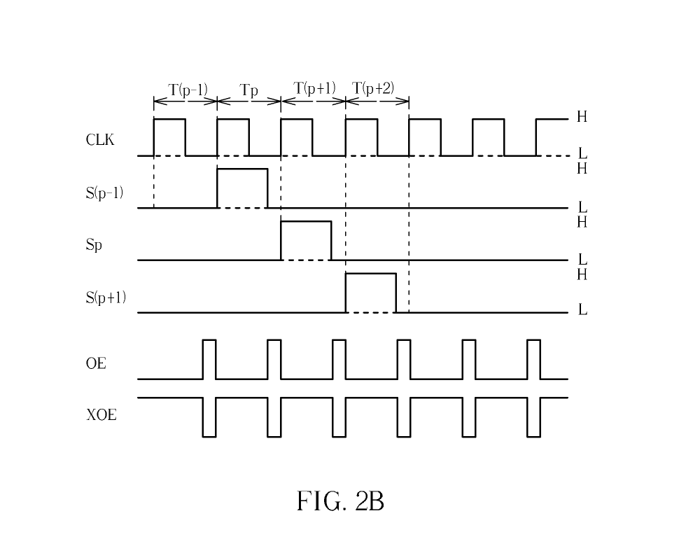

FIG. 2A and FIG. 2B are the block diagram and timing diagram of the second embodiment of the (p−1)th, pth, and (p+1)th gate-driving circuits 211. Each blocking circuit 212 of the gate-driving circuit 211 includes a first NMOS switch 200 and a second NMOS switch 202. The drain of first NMOS switch 200 is connected to the shift register 411, while the source of second switch 202 is connected to the low-voltage-level source (VSS), and its drain is connected the source of the first NMOS switch 200. The control signals of OE and XOE simultaneously control these two NMOS switches 200 and 202 for blocking the scan signals up to a predetermined time period. The control signal XOE is the inverse of the control signal OE. The difference between the first and second embodiments is that the peripheral circuits and pixel matrix 230 of the liquid crystal display 198 are mainly formed of NMOS, thus simplifying the process and reducing the cost. Besides, the invention provides a method to control simultaneously the blocking circuits 212 with a plurality of control signals having different voltage-phases, for obtaining the non-overlapping scan signals outputted by the gate-driving circuits 211. Subsequently, those non-overlapping scan signals are transferred to the corresponding gate lines.

A small time period before the time period Tp ends, the control signal OE and its inverse XOE are set to high (˜VDD) and low (˜VSS) voltage levels respectively and maintained at those voltage levels until the end of the time period Tp, so that the rising edge of pth scan signal is triggered later than the falling edge of (p−1)th scan signal. That is, the control signals and blocking circuits 212 connected to the shift registers 411 are used to provide the non-overlapping scan signals for the corresponding gate lines. Similarly, the (p+1)th gate-driving circuit 211 outputs the scan signal S(p+1) at the time period T(p+2).

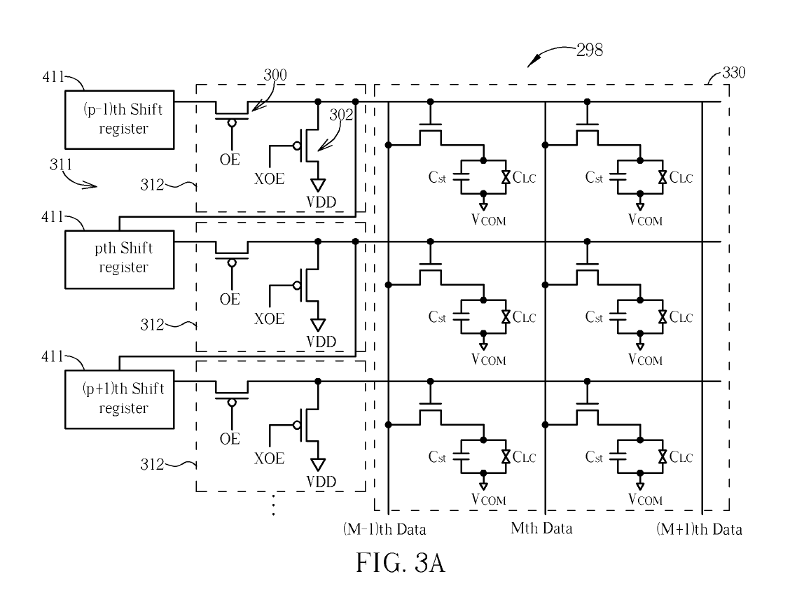

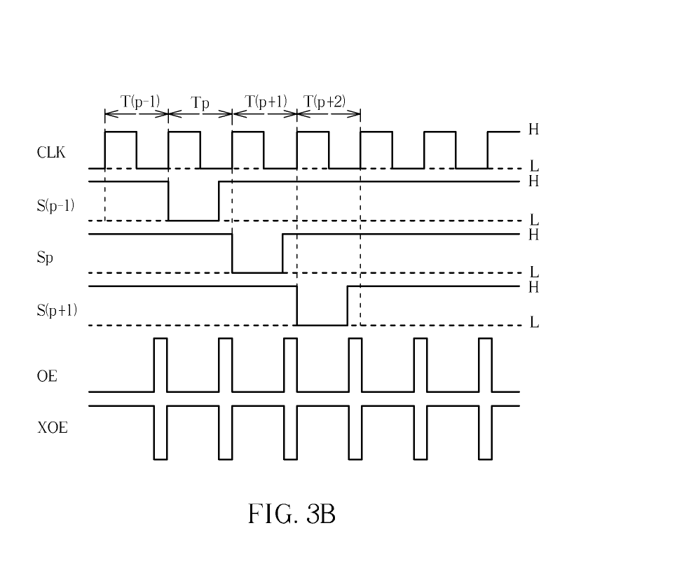

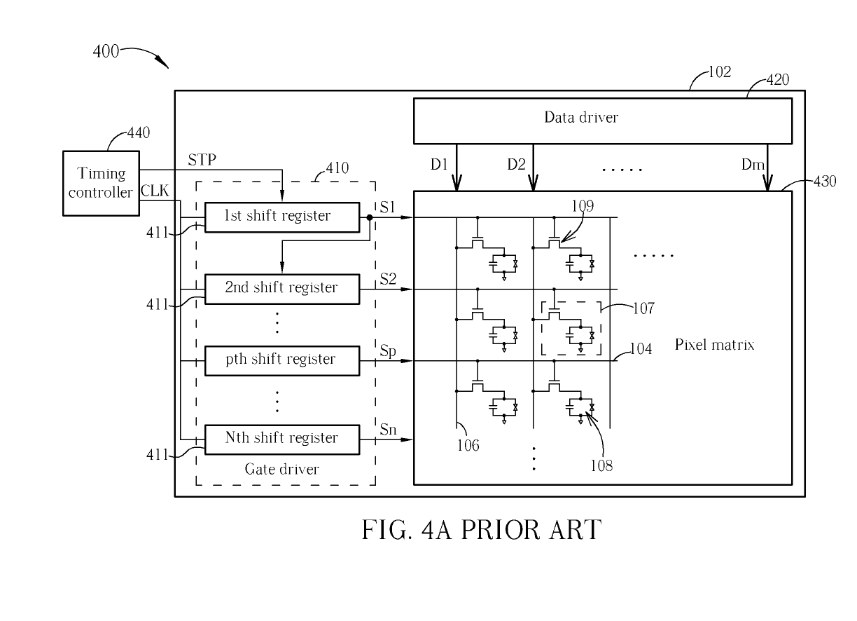

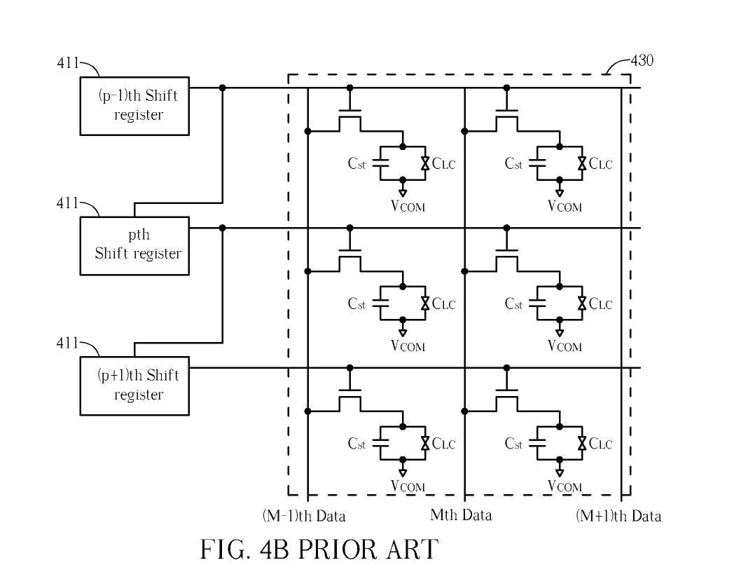

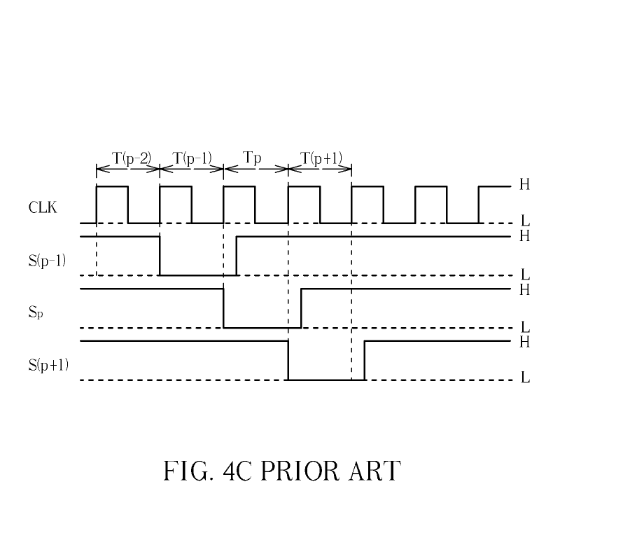

FIG. 3A and FIG. 3B are the block diagram and timing diagram of the third embodiment of the (p−1)th, pth, and (p+1)th gate-driving circuits 311. Each blocking circuit 312 of the gate-driving circuit 311 includes a first PMOS switch 300 and a second PMOS switch 302. The source of the first PMOS switch 300 is connected to the shift register 411. The drain of the second switch 302 is connected to the high-voltage-level source (VDD), and its source is connected the drain of the first PMOS switch 300. The difference between the first and third embodiments is that the peripheral circuits and pixel matrix 330 of the liquid crystal display 298 are mainly formed of PMOS, thus simplifying the process and reducing the cost. Besides, the invention provides a method to control simultaneously the blocking circuits 312 with a plurality of control signals having different voltage-phases, for obtaining the non-overlapping scan signals outputted by the gate-driving circuits 311. Subsequently, those non-overlapping scan signals are transferred to the corresponding gate lines.

A small time period before the time period Tp ends, the control signal OE and its inverse XOE are set to high (˜VDD) and low (˜VSS) voltage levels respectively and maintained at those voltage levels until the end of the time period Tp, so that the falling time of pth scan signal is triggered after the rising edge of (p−1)th scan signal. That is, the control signals and blocking circuits 312 connected to the shift registers 411 are used to provide the non-overlapping scan signals for the corresponding gate lines. Similarly, the (p+1)th gate-driving circuit 311 outputs scan signal S(p+1) at the time period T(p+2).

Therefore, the invention provides the LCD displays with a gate driver outputting non-overlapping scan signals and the method to executing that display. The non-overlapping scan signals outputted by the gate-driving circuits 111, 211, 311 are obtained and transferred to the corresponding gate lines, the gate-driving circuits 111, 211, 311 can be formed with peripheral circuits and pixel matrices of CMOS, NMOS or PMOS structures. Thus, the invention will improve the image quality of LCD displays.

Those skilled in the art will readily observe that numerous modifications and alterations of the device and method may be made.

What is claimed is:

1. A gate driver comprising:
a plurality of cascaded gate driving circuits for outputting a plurality of scan signals, each of the gate driving circuits comprising:
a shift register for outputting a scan signal according to clock pulses and a scan signal outputted by a former gate driving circuit; and
a blocking circuit coupled to the shift register for blocking the scan signal generated by the shift register a predetermined time period.

2. The gate driver of claim 1, wherein the blocking circuit comprises an NMOS switch and a PMOS switch.

3. The gate driver of claim 1, wherein the blocking circuit comprises:
a first NMOS switch comprising:
a source coupled to a gate line; and
a drain coupled to the shift register; and
a second NMOS switch comprising:
a drain coupled to the gate line; and
a source coupled to a low voltage source.

4. The gate driver of claim 1, wherein the blocking circuit comprises:
a first PMOS switch comprising:
a drain coupled to a gate line; and
a source coupled to the shift register; and
a second PMOS switch comprising:
a drain coupled to the gate line; and
a source coupled to a high voltage source.

5. A liquid crystal display comprising:
a substrate;
a plurality of gate lines arranged on the substrate;
a plurality of data lines arranged on the substrate and intersecting the gate lines;
a plurality of pixels each comprising a thin film transistor and a pixel capacitor, the thin film transistor being coupled to a data line and a gate line, the pixel capacitor being coupled to the thin film transistor;
a data driver for outputting a plurality of data signals to the data lines; and
a gate driver comprising a plurality of cascaded gate driving circuits for outputting a plurality of scan signals, each of the gate driving circuits comprising:
a shift register for outputting a scan signal according to clock pulses and a scan signal outputted by a former gate driving circuit; and
a blocking circuit coupled to the shift register for blocking the scan signal generated by the shift register a predetermined time period.

6. The liquid crystal display of claim 5, wherein the blocking circuit comprises an NMOS switch and a PMOS switch.

7. The liquid crystal display of claim 5, wherein the blocking circuit comprises:
a first NMOS switch comprising:
a source coupled to the gate line; and
a drain coupled to the shift register; and
a second NMOS switch comprising:
a drain coupled to the gate line; and
a source coupled to a low voltage source.

8. The liquid crystal display of claim 5, wherein the blocking circuit comprises:
a first PMOS switch comprising:
a drain coupled to the gate line; and
a source coupled to the shift register; and
a second PMOS switch comprising:
a drain coupled to the gate line; and
a source coupled to a high voltage source.

9. The liquid crystal display of claim 5, wherein a data driver is capable of generating control signals for controlling the blocking circuit.

10. A method for generating a non-overlapping scan signal in a liquid crystal display, comprising:
generating a scan signal by a shift register according to clock pulses and a scan signal outputted by a previous shift register; and
when the shift register outputs the scan signal for a duty cycle, generating control signals to control a blocking circuit coupled to the shift register to block the scan signal generated by the shift register for a predetermined time period.

11. The method of claim 10 wherein the blocking circuit comprises a PMOS switch and an NMOS switch, a source of the PMOS switch being coupled to the shift register, a source of the NMOS switch being coupled to a low voltage source, the control signals being in phase for controlling the PMOS and NMOS switches simultaneously for blocking the scan signal generated by the shift register for the predetermined time period.

12. The method of claim 10 wherein the blocking circuit comprises a PMOS switch and an NMOS switch, a source of the PMOS switch being coupled to a high voltage source, a drain of the NMOS switch being coupled to the shift register, the control signals being in phase for controlling the PMOS and NMOS switches simultaneously for blocking the scan signal generated by the shift register for the predetermined time period.

13. The method of claim 10 wherein the blocking circuit comprises a first NMOS switch and a second NMOS switch, a drain of the first NMOS switch being coupled to the shift register, a source of the second NMOS switch being coupled to a low voltage source, the control signals having opposite phases for controlling the two NMOS switches simultaneously for blocking the scan signal generated by the shift register for the predetermined time period.

14. The method of claim 10 wherein the blocking circuit comprises a first PMOS switch and a second PMOS switch, a source of the first PMOS switch being coupled to the shift register, a source of the second PMOS switch being coupled to a high voltage source, the control signals having opposite phases for controlling the two PMOS switches simultaneously for blocking the scan signal generated by the shift register for the predetermined time period.
